(19) United States
(12) Patent Application Publication
(10) Pub. No.: US 2023/0329218 A1
(43) Pub. Date: Oct. 19, 2023

(54) AGRICULTURAL DISTRIBUTION MACHINE HAVING A DISTRIBUTION LINKAGE, AND METHOD FOR CONTROLLING THE DISTRIBUTION LINKAGE

(71) Applicant: HORSCH LEEB Application Systems GmbH, Landau an der Isar (DE)

(72) Inventor: Florian ZINK, Landau An Der Isar (DE)

(73) Assignee: HORSCH LEEB Application Systems GmbH, Landau an der Isar (DE)

(21) Appl. No.: 18/299,476

(22) Filed: Apr. 12, 2023

(30) Foreign Application Priority Data
Apr. 13, 2022 (DE) 10 2022 109 092.2

(51) Int. Cl. B05B 12/12; A01C 23/04; A01M 7/00

(52) U.S. Cl. CPC A01M 7/0057; A01C 23/047; B05B 12/124

(57) ABSTRACT

The invention relates to an agricultural distribution machinehaving a distribution linkage for applying agricultural material with two lateral booms, each having a plurality of application elements for applying the material, and a method of operation thereof. The distribution machine includes a controllable actuating device for altering a position of the distribution linkage relative to a target agricultural area to be worked, a sensor device configured to sense in anticipation changing vertical distances between the distribution linkage and the target area and/or upcoming changes in contour of the target area, and a control device that, for the purpose of controlling the position, preferably controlling the height, of the distribution linkage, is configured to generate actuating signals for the actuating means based upon the changing vertical distances sensed in anticipation and/or changes in contour, in order to at least partially reduce a response time in the position control device.

### CROSS-REFERENCE TO RELATED APPLICATIONS

This application claims the benefit of German Patent Application No. DE 10 2022 109 092.2, filed Apr. 13, 2022, the disclosure of which is hereby incorporated herein in its entirety by reference.

### BACKGROUND OF THE INVENTION

### Field of the Invention

The invention relates to an agricultural distribution machine, preferably a field sprayer or a pneumatic fertiliser spreader, having a distribution linkage of wide working width for applying material such as fertiliser, plant protectant or seed. The invention further relates to a method for controlling the position of such a distribution linkage.

### SUMMARY OF THE INVENTION

### Background & Description of Related Art

It is known from prior art to use such agricultural distribution machines (hereinafter also referred to in short as distribution machines) for the uniform distribution of liquid and/or solid agricultural agents onto an agricultural area to be treated. In order to achieve the greatest possible effectiveness, such distribution machines have a distribution linkage extending over a wide width, transversely with respect to the direction of travel of the distribution machine. For distributing the respective agents, there are distribution elements such as, for example, spray nozzles, impact elements or the like are attached to the distribution linkage.

During application, the distance between the distribution linkage and the ground or the crop should remain as constant as possible over the entire working width. For the purpose of controlling the position of the distribution linkage, in particular to adapt its height relative to a crop, it is known from prior art to hold the distribution linkage on the carrier vehicle in a height-adjustable manner by device of an actuating device. Furthermore, actuating device are known that set a pivot position of the distribution linkage about a pivot axis extending in the direction of travel, or that set an angling of the booms in relation to each other or of boom segments in relation to each other.

For the purpose of sensing the vertical position in the context of controlling the position of the distribution linkage, it is also known from the prior art to provide on the distribution linkage ultrasonic sensors that are oriented in the direction of the crop, i.e. directed substantially vertically downwards, by means of which an actual distance between the distribution linkage and the crop, or to the arable area, can be sensed.

However, known systems for controlling the position of the distribution linkage that use such ultrasonic sensors have the disadvantage that the position control of the linkage can often respond too late to changing vertical distances between the distribution linkage and the crop. The reason is the comparatively long system response time, i.e. the time that elapses between sensing of the vertical position and an actual adaptation, i.e. an alteration of the position of the distribution linkage. This response time is influenced, for example, by the comparatively high mass inertia of the linkage, the response time of the actuating device, e.g. hydraulics thereof, and the time taken to process the sensor data.

If a response time of 1.2 s is assumed for this, merely as an example, this would result in a travel distance of six metres, based on a travel speed of, for example, 18 km/h = 5 m/s, until the closed-loop control for attaining the desired vertical position begins, or until this vertical position is attained. The adaptation is thus affected too late. Furthermore, within this six-metre travel distance, the vertical position can already change again, such that consequently a sufficiently precise adaptation of the position of the distribution linkage to changing vertical distances is not possible.

It is therefore an object of the invention to provide an improved technique for controlling the position of the distribution linkage for adaptation to changing vertical distances with respect to a crop or an arable area, by which disadvantages of conventional techniques can be avoided. The object of the invention is in particular to provide a technique for controlling the position of the distribution linkage that enables the position of the distribution linkage to be adapted more rapidly to changing vertical distances.

These objects are achieved by devices and methods having the features of the independent claims. Advantageous developments are indicated in the dependent claims and the description.

According to a first general aspect, an agricultural distribution machine is provided. The distribution machine comprises a distribution linkage for applying material such as fertiliser, plant protectant or seed. The distribution linkage, hereinafter also referred to in short as a linkage, comprises two lateral booms (linkage wings), each having a plurality of application elements for applying the material. The distribution linkage preferably further comprises a central part on which the lateral booms are each mounted so as to be pivotable on the central part about an axis (boom axis) extending in the direction of travel. The central part may likewise have a plurality of application elements for applying the material.

The distribution machine may be a field sprayer, the application elements of which are in the form of spray nozzles. Further, the distribution machine may be a pneumatic fertiliser spreader, on which granular spreading material can be conveyed along distribution lines, which are arranged at least in sections on the distribution linkage, by means of an air volume flow in the direction of the application elements. In this case, the application element may have, for example, a baffle plate.

The distribution machine further comprises a controllable actuating device for altering a position of the distribution linkage relative to a target agricultural area to be worked.

The distribution machine further comprises a sensor device, which is configured to sense in anticipation changing vertical distances between the distribution linkage and the target area and/or upcoming changes in contour of the target area, preferably to sense in anticipation changing vertical distances between the distribution linkage and the target area in the direction of travel and/or changing ground reliefs. In other words, the sensor device is configured to sense, with respect to the distribution linkage in the direction of travel, upcoming changes in a vertical distance between the distribution linkage and the target area directly and/or on the basis of upcoming changes in contour of the target area, i.e. to anticipate upcoming changes in a vertical distance and/or contour of the target area, e.g. a ground relief, before the distribution linkage reaches it.

The distribution machine further comprises a control device that, for the purpose of controlling the position of the distribution linkage, is configured to generate actuating signals for the actuating device based upon the changing vertical distances sensed in anticipation, preferably in order to at least partially compensate or reduce a response time in the position control device.

A response time in the position control may be understood as the technically contingent delay time that elapses between the sensing of a changing vertical distance (h) and/or of a change in contour and an adaptation of the position of the distribution linkage to the changed vertical position.

It has already been mentioned above that currently the response time is influenced, for example, by the time taken to process the sensor data, the response time of the actuating device, e.g. a respective response time of the hydraulics in the case of hydraulic actuating device, and the mass inertia of the distribution linkage. By anticipatory sensing changing vertical distances, the control device can generate actuating signals for the purpose of adaptation to these changing vertical distances before the distribution linkage reaches a changed vertical distance. Accordingly, the response time for this adaptation can be compensated at least partially, preferably completely. Advantageously, according to the invention, a more rapid adaptation of the position of the distribution linkage to changing vertical distances can be achieved.

The target area may be an agricultural area to be treated. The target area may be a stand area, e.g. of a crop, or an arable area. The vertical distance may be the distance from an underside of the distribution linkage to a top side of a crop. The position control of the distribution linkage may be a control of the height of the distribution linkage relative to the target area.

In a further preferred embodiment, the sensor device is configured to sense the vertical distance between the distribution linkage and the target area at different measurement locations that are spaced apart from each other in the direction of travel. At least some of the different measurement locations - as viewed in the direction of travel - may be located several metres ahead of the distribution linkage. A measurement location may also be located directly beneath or diagonally beneath the distribution linkage. This means that only one of the measurement locations may be used for anticipatory sensing of changing vertical distances and/or changes in contour, and the other for sensing the actual vertical distance and/or the actual contour.

The different measurement locations that are spaced apart from each other in the direction of travel, may - as viewed in the direction of travel - lie on a line or be offset from each other transversely with respect to the direction of travel. This can be advantageous, for example, with regard to ridge cultivations, i.e. if, for example, the ridges differ in height.

A measurement location is a measurement point and/or a measurement region at which a contour of the target area, a vertical distance between the target area and the distribution linkage, and/or a change in this vertical distance is sampled. The contour may be referred to as a height profile. The different measurement locations may also comprise a plurality of measurement locations that - as viewed in the direction of longitudinal extent of the distribution linkage - are arranged at a distance from each other and are each at the same distance - as viewed in the direction of travel - from the distribution linkage.

In a particularly preferred embodiment, the sensor device may further be configured to sense actual values relating to the vertical distance between the distribution linkage and the target area. The actual values indicate the current vertical distance (actual vertical distance) between the distribution linkage and the target area.

In one embodiment, the sensor device is configured to sense the vertical distance between the distribution linkage and the target area at a first measurement location for the purpose of sensing actual values relating to the vertical distance, and at a second measurement location for the purpose of sensing upcoming values relating to the vertical distance, the second measurement location -as viewed in the direction of travel - being located at least partially ahead of the first measurement location, further preferably located at a distance of several metres ahead of the first measurement location. Alternatively or additionally, the sensor device may be configured to scan a contour of the target area at a first measurement location and at a second measurement location, the second measurement location -as viewed in the direction of travel - being located at least partially ahead of the first measurement location, further preferably located at a distance of several metres ahead of the first measurement location.

These embodiments make use of the insight that vertical distance data at the first measurement location are sensed more accurately, but too late to compensate the response time, whereas vertical distance data at the second measurement location can be sensed less accurately in comparison, but in anticipation, so that it is possible to respond to changing vertical distance data at an early stage. The use of vertical distance data from both measurement locations in combination enables rapid and particularly accurate control of the position of the distribution linkage in response to changing vertical distances between the distribution linkage and the target area.

In a preferred embodiment, the control device is configured, on the basis of the actual values, to check and/or calibrate the changing vertical distances sensed in anticipation. Alternatively or additionally, the control device may be designed, on the basis of the actual values, to adjust, in particular readjust, a current vertical distance of the distribution linkage to a setpoint vertical distance, the current vertical distance having been set previously on the basis of the changing vertical distances sensed in anticipation, e.g. as part of a pre-control.

The indefinite articles “a” or “an” do not preclude a plurality of the characteristics denoted thereby. Thus, both the previous and the following expressions that include “a” or “an” are to be understood as “at least one”. Specifically, in a further embodiment variant, the sensor device may be configured to sense measurement values at a plurality of such first and second measurement locations. In this case, the plurality of first measurement locations are each arranged at a distance from one another - as viewed in the direction of longitudinal extent of the distribution linkage - and each are at the same distance - as viewed in the direction of travel - from the distribution linkage (assuming a horizontal target area). The same applies to the plurality of second measurement locations, which, however -as viewed in the direction of travel - are located at least partially ahead of the first measurement locations.

The sensor device may realize, for example, a plurality of pairs of first and second measurement locations, the pairs respectively formed from a first and second measurement location being arranged at a distance from one another, as viewed in the longitudinal direction of the distribution linkage. For this purpose, the sensor device may comprise a plurality of sensor arrangements or sensors that, as viewed in the longitudinal direction of the distribution linkage, are arranged at correspondingly spaced intervals on the distribution linkage. This is advantageous for anticipatory sensing of upcoming changes in height at a plurality of locations along the working width of the distribution machine. These sensor arrangements may each comprise a close-range sensor and a far-range sensor, as will be further described below. Thus, a plurality of pairs of respectively one close-range and one far-range sensor may be provided, distributed along the distribution linkage.

It is emphasised that, for the embodiment variants described above, it is not necessary to know the response time for controlling the position of the distribution linkage and/or to store it in the control device. As long as changing vertical distances are sensed in anticipation on the basis of the second measurement location(s), the response time, irrespective of its duration, can be at least partially compensated by an anticipatory adaptation of the position of the linkage. The more the changing vertical distances are sensed in anticipation, the more the response time can be compensated.

Preferably, the control device is configured to indirectly or directly determine a time point for the generation of an actuating signal for at least partial compensation of the response time in the position control based upon the travel speed and/or a variable derived therefrom, such as, for example, the linkage speed at a certain point on the distribution linkage in the direction of travel, preferably in such a manner that a travel time, remaining after the time point, until the changing vertical distance sensed in anticipation and/or changes in contour is/are reached, and/or until the second measurement location is reached, substantially corresponds to the response time of the actuating device in the position control.

This is particularly advantageous because in this case the linkage position is adapted to an upcoming change in vertical distance substantially precisely when the distribution linkage passes over the change in vertical distance, such that the change in vertical distance is not adjusted too late and not too early. For implementation, the response time of the actuating device, which takes up a large part of the total response time, may be determined experimentally in advance in trials for the specific type of linkage control and the specific design of the distribution machine, and the location of the second measurement location and/or the time point for generating the actuating signal may expediently be determined accordingly. The response time may also be measured, for example, during the operation of the distribution machine, for example as the time that elapses between sensing of a signal by the sensor device and the movement of the distribution linkage generated in response thereto by the control device.

In a further preferred embodiment, the first measurement location corresponds to a close range beneath or diagonally down ahead of the distribution linkage. Diagonally down ahead of the distribution linkage device means diagonally down ahead of the distribution linkage as viewed in the direction of travel. Alternatively or additionally, the first measurement location may comprise measurement points from a range that - as viewed in the direction of travel - is at a distance in a range of from zero metres to one metre from the distribution linkage. The second measurement location may correspond to a far range that - as viewed in the direction of travel - is located ahead of, or at least largely ahead of, the close range. Alternatively or additionally, the second measurement location may comprise measurement points from a range that - as viewed in the direction of travel - is at a distance in a range of from one to x metres from the distribution linkage. In this case, X may have a value of, for example, 50 metres, 20 metres, 10 metres or 6 metres. Such close and far ranges are particularly advantageous with regard to typical travel speeds and usual response times of distribution machines. The distance between the first measurement location and/or the second measurement location and the distribution linkage - as viewed in the direction of travel - may optionally also be such that it can be altered dynamically. For example, a sensor for alteration of the distance may be arranged in a pivotable manner on the distribution linkage.

Advantageous embodiments of the sensor device for sensing the above measurement values at the first and second measurement locations are described below.

In a particularly preferred embodiment, the sensor device comprises a first sensor, hereinafter referred to as a close-range sensor, which is configured to sense, at a first measurement location, actual values relating to the vertical distance between the distribution linkage and the target area and/or to scan an actual contour, e.g. an actual height profile, of the target area. According to this embodiment, the sensor device comprises a second sensor, hereinafter referred to as a far-range sensor, which is configured to sense, at a second measurement location, upcoming values relating to the vertical distance at a second measurement location and/or to scan an upcoming contour, e.g. an upcoming height profile, of the target area, the second measurement location - as viewed in the direction of travel - being at least partially ahead of the first measurement location. With this sensor arrangement, both actual values and upcoming relating to the vertical distance can be sensed.

The close-range sensor and/or the far-range sensor may each be in the form of an ultrasonic sensor. However, other types of sensors for distance measurement are also possible. For example, the far-range sensor may be in the form of a radar sensor.

The close-range sensor and/or the far-range sensor may be arranged on the distribution linkage. This enables direct sensing of the vertical distance between the distribution linkage and the target area. An arrangement in which the close-range sensor and the far-range sensor are arranged at the same point on the distribution linkage, for example above or next to each other at the same point, is particularly advantageous. This facilitates comparison of the measurement data of the two sensors.

Compared to the close-range sensor, the far-range sensor may have a direction of view that is oriented further forward towards the target area. Forward means as viewed from the distribution linkage in the direction of travel. The close-range sensor may have a downward or downwardly oblique direction of view that forms, with a vertical, an angle in the range of from 0° to 60°, preferably 0° to 20°. The close-range sensor can therefore view directly vertically downwards or slightly forwards, or obliquely downwards, in the direction of travel. The far-range sensor may have a direction of view oriented obliquely forward that, in comparison of the direction of view of the close-range sensor, is directed further forward. The direction of view of the far-range sensor may form, with a vertical, an angle in a range of from 5° to 90° or in a range of from 15° to 70 to the vertical.

According to a further embodiment, the control device is configured to check and preferably calibrate measurement data of the far-range sensor at a time point on the basis of measurement data of the close-range sensor, preferably measurement data at a time point t+x, where t+x corresponds to the time at which the first measurement location (M1) reaches the location of the second measurement location (M2) in the current travel operation. Thus, x corresponds to the travel time of the distribution linkage from the first to the second measurement location. The far-range sensor measures less accurately because it has a flatter measuring angle compared to the close-range sensor. This embodiment allows the quality of the measurement values of the far-range sensor to be checked, which can also be used advantageously for its calibration during operation of the distribution machine.

For example, the control device may be configured such that, if the check reveals a deviation between a vertical distance determined by means of the measurement data of the far-range sensor at the time point t and a vertical distance determined by means of the measurement data of the close-range sensor at the time point t+x, it sets this deviation as an offset or as a correction value for the measurement data of the far-range sensor, and preferably continuously adapts the correction value. The accuracy of the anticipatory sensing of changes in height can thereby be improved.

In a further preferred embodiment, the far-range sensor may be configured for environment detection, preferably for the detection of obstacles and/or field boundaries. According to this embodiment, the far-range sensor can be used in a dual function. For this embodiment, it is particularly advantageous if the far-range sensor is realized as a radar sensor. The radar sensor may be designed, for example, to sense an additional upcoming region in addition to the target area at the second measurement location, to enable concomitant sensing of obstacles, such as trees, or field boundaries, for example.

In a further preferred embodiment, a direction of view of the far-range sensor can be altered, preferably altered in an automated manner, for the purpose of altering the position of the second measurement location or selecting another measurement location as the second measurement location.

Preferably, the control device is configured to alter the direction of view of the far-range sensor based upon the travel speed or a variable derived therefrom, in such a manner that, as the travel speed increases, the direction of view is altered to be further forwards. Advantageously, this can counteract the effect whereby, as travel speed increases, there is less time available for response to upcoming, changing vertical distances.

It is particularly advantageous if the variable derived therefrom is the linkage speed in the direction of travel at a predetermined point on the distribution linkage. The linkage speed depends on the travel speed. During travel along curves, however, there are differences in speed along the distribution linkage. Thus, the linkage speed of the boom that is radially on the outside with respect to travel along curves is greater than the linkage speed of the boom that is radially on the inside. Correspondingly, during travel along curves there are also different linkage speeds along the booms, or their different segments, in the direction of travel.

Particularly preferred, therefore, is an embodiment in which the direction of view of the far-range sensor is altered based upon the linkage speed of the distribution linkage, in particular on the speed of the distribution linkage in the direction of travel at the point where the respective far-range sensor is arranged on the linkage. This embodiment is particularly advantageous if the sensor device comprises a plurality of far-range sensors, with there being at least one far-range sensor arranged on each boom.

In a further preferred embodiment, the control device may be configured to dynamically direct the direction of view of the far-range sensor to an upcoming measurement location that is spaced ahead of the distribution linkage, such that a travel time required, on the basis of the current travel speed, until the distribution linkage reaches this measurement location substantially corresponds to the response time or a variable derived therefrom.

In this case, advantageously, the linkage position can be adjusted to an upcoming change in vertical distance with respect to the target area substantially precisely when the distribution linkage passes over the change in height, such that the change in height is not adjusted too late (and not too early).

According to a further exemplary embodiment, the far-range sensor may be arranged in a pivotable manner on the distribution linkage for the purpose of altering the direction of view. It is particularly advantageous if it is in the form of an ultrasonic sensor that is arranged on the distribution linkage so that it can be pivoted and can also preferably be driven by the control device for the purpose of altering its pivot position and thus the direction of view. The pivoting may be effected manually or by an actuator, for example one that can be actuated electrically, that can be driven accordingly by the control device. In this case, it is also possible for no close-range sensor to be provided.

Alternatively or additionally, the sensor device may include a radar sensor that is configured to measure the vertical distance between the distribution linkage and the target area at a plurality of measurement locations that are spaced apart from each other in the direction of travel. The advantage of a radar sensor is that the target area can be scanned at a plurality of measurement locations simultaneously. The radar sensor can thus combine the function of a close-range sensor and a far-range sensor, and/or unite them in one sensor or device.

Furthermore, the control device may optionally be configured to select one or more measurement locations from the plurality of measurement locations of the radar sensor based upon the travel speed or a variable derived therefrom. This selection may preferably be effected in such a manner that, as the travel speed increases, one or more measurement location(s) further forward in the direction of travel is/are selected. In other words, the measurement points of the radar sensor that are used for calculation of the upcoming changing vertical distance or the upcoming change in contour in relation to the target area are adapted so that, for example, depending on the travel speed, measurement points at different distances ahead of the distribution linkage are selected.

This selection of one or more measurement location(s) may be regarded as an alteration of the direction of view of the radar sensor based upon the travel speed or a variable derived from it. Although the radar sensor itself does not have to be pivoted for this purpose, as is the case with an ultrasonic sensor, for example, a suitable measurement location may be selected from the plurality of available measurement locations such that only the radar signals of this measurement location are evaluated with regard to the sensing of changes in vertical distance, which corresponds to a change in the direction of view, or sensing direction. The far-range sensor may be realized as a radar sensor.

In a further embodiment, the control device is configured to determine in anticipation, based upon the measurement values sensed at the second measurement location and/or based upon the measurement values sensed by the far-range sensor, a change in vertical distance, or a variable derived therefrom, that indicates whether the vertical distance between the distribution linkage and the target area remains the same, decreases or increases in comparison with the current vertical distance. Particularly preferably, the change in vertical distance that is sensed in anticipation indicates only whether the vertical distance between the distribution linkage and the target area remains the same, decreases or increases in comparison with the current vertical distance. In this case, the control device is also configured to generate an actuating signal for the actuating device, before the distribution linkage reaches the second measurement location, based upon the determined change in vertical distance or the variable derived therefrom, preferably for the purpose of adapting the position of the distribution linkage to the change in vertical distance.

This embodiment makes use of the knowledge that the upcoming change in vertical distance does not necessarily have to be accurately determined numerically, but sensing of whether the vertical distance remains the same, decreases or increases can itself be used advantageously for rapid pre-control. In this way, the distribution linkage can already be moved in the correct direction with regard to the coming change in height, before it reaches the corresponding change in height. For example, the control device may be configured to determine a gradient of the vertical distance between the distribution linkage and the target area based upon the changing vertical distances sensed in anticipation and/or changes in contour. For example, the change in vertical distance sensed, for example by means of the far-range sensor, or the variable derived therefrom may be determined as a gradient of the vertical distance between the distribution linkage and the target area, in which case, further preferably, only a direction of the gradient and not a magnitude of the gradient is determined.

In a further possible embodiment, the control device is configured to determine a value for the actuating signal in proportion to a value of the changing vertical distance (h) sensed in anticipation and/or change in contour. For example, the control device may be configured to determine a value for the actuating signal in proportion to a value of the change in vertical distance sensed and/or determined in anticipation, or of the variable derived therefrom. This allows the position of the linkage to be adapted in a particularly precise manner to the change in vertical distance.

Alternatively, the control device may be configured to generate, based upon the changing vertical distance (h) sensed in anticipation and/or change in contour, and/or based upon the determined change in vertical distance or the variable derived therefrom, an actuating signal that causes the position of the distribution linkage to be altered by an offset value relative to the agricultural target area to be worked. In the case of this variant, the positioning movement of the distribution linkage driven by the control device is not proportional to the change in vertical distance, but rather the position of the distribution linkage is merely altered by an offset value. A particular advantage is that the amount of the change in height does not have to be sensed in anticipation, or not very precisely, and simplified and more rapid data processing is made possible.

Merely by way of example, an offset value of 5 or 10 cm may be selected, i.e. if an increase in the vertical distance is detected in anticipation, the vertical distance between the distribution linkage and the target area is reduced in anticipation by 5 or 10 cm. If a reduction of the vertical distance is detected in anticipation, the vertical distance is increased in anticipation by 5 or 10 cm. It is also optionally possible to store a plurality of offset values in advance, in order to select one of the stored offset values based upon the sensed change in vertical distance. The offset values can thus be used to realize a discrete pre-control in order to adapt the position of the distribution linkage to predicted changes in height.

In one embodiment, the control device may be configured to determine an actual vertical distance (current vertical distance) between the distribution linkage and the target area based upon the measurement values sensed at the first measurement location and/or based upon the measurement values sensed by the close-range sensor, and to use this to adjust the actual vertical distance to a setpoint vertical distance. This offers the advantage that remaining deviations from the setpoint vertical distance, which result from the pre-control based on the measurement values of the second measurement location, can then be rapidly and reliably corrected.

In a further embodiment, the control device may be configured to determine, based upon the measurement values sensed by the sensor device, whether a switchover condition is fulfilled and, if the switchover condition is fulfilled, to change from a first operating mode to a second operating mode if the switching condition is fulfilled. In the first operating mode, the vertical distance of the distribution linkage is adjusted to a setpoint vertical distance based upon the measurement values sensed at the first measurement location and/or based upon the measurement values sensed by the close-range sensor. In the second operating mode, actuating signals for alteration of the position of the distribution linkage are generated by the control device based upon the changing vertical distances sensed in anticipation at the second measurement location and/or based upon the vertical distances sensed by the far-range sensor, which actuating signals cause a current position of the distribution linkage to be adapted to the changing vertical distances before the second measurement location is reached. This renders possible a simple change between a conventional closed-loop control of the actual vertical distance to a setpoint vertical distance (first operating mode) and an additional anticipatory adaptation of the vertical distance (second operating mode).

The switchover condition may be fulfilled, for example, if an upcoming change in vertical distance between the distribution linkage and the target area, or a variable derived therefrom, the amount of which exceeds a predetermined threshold value, is determined on the basis of the measurement values sensed at the second measurement location and/or on the basis of the measurement values sensed by the far-range sensor. It can thereby be ensured, advantageously, that changing to the second operating mode is effected only in the case of relatively large changes in vertical distance sensed in anticipation, in order to avoid constant changing back and forth between the first and second operating modes.

A further embodiment thereof may provide that, if the predetermined threshold is exceeded and would require lowering of the distribution linkage or segments thereof, the switchover condition is fulfilled only if no gap in the crop and/or no risk of contact with the ground or crushing of the crop by the distribution linkage is detected. Advantageously, damage and incorrect control of the distribution linkage can thereby be better avoided.

The presence of a gap in the crop, the risk of contact with the ground or of crushing of the crop may be determined and/or estimated, for example, on the basis the measurement values sensed at the first measurement location or sensed by means of further sensors, e.g. a close-range sensor (see description below). A gap in the crop may be a discontinuity in the crop that does not extend over the entire working width of the distribution machine.

In a further embodiment, the control device may be configured to factor out in the height control a deviation of the distribution linkage from a setpoint position, caused by a linkage oscillation of the distribution linkage, preferably in such a manner that vertical oscillations and/or horizontal oscillations of the distribution linkage do not affect the determination of the vertical distance of the distribution linkage and/or the height control. Accordingly, accurate sensing of vertical distances and improved position control can be achieved.

In a further embodiment, the control device may be configured to form an average value based upon vertical distances determined at the different measurement locations, which is used to generate the actuating signals and/or to control the position of the distribution linkage. It has already been explained above that upcoming height changes can be sensed early, but somewhat less accurately, on the basis of the measurement values sensed at the second measurement location, and actual changes in height can be sensed comparatively accurately on the basis of the measurement values sensed at the first measurement location. The use of the average value enables a simple use of both advantages. Accordingly, the average value may also be formed by averaging the vertical distances determined by the close-range sensor and those determined by the far-range sensor.

In a further embodiment, the response time and/or the system speed may be stored in the control device in the controlling of the position of the distribution linkage. Alternatively or additionally, the control device may be configured to determine the response time and/or the system speed on the basis of a time measurement. Different response times and/or system speeds may be stored for different types of position control.

It has already been stated above that a response time in the position control may be understood as the technically contingent delay time that elapses between the sensing of a changing vertical distance (h) and/or a of change in contour and an adaptation of the position of the distribution linkage to the changed vertical position. The response time in the position control is composed of a response time of the sensor device, the control device and the actuating device. The response time depends on the system speed, in particular the system speed of the actuating device. The system speed itself, in turn, can vary, e.g. based upon the difference in vertical position. The control device may be configured to influence the system speed. For example, actuating signals that correspond more to an abrupt (rapid) control or more to a softer (slow) control may optionally be generated for the actuating device. Accordingly, actuating movements may be generated that follow different ramps.

For example, actuating signals may optionally be generated for the actuating means that cause a rather “soft” and possibly not exact approach to a setpoint position of the distribution linkage, or that cause an abrupt and possibly more exact approach to the setpoint position. In the case of a fluid-actuated actuating device, e.g. having hydraulically operating actuating cylinders, the system speed may be influenced by device of a volume-flow control, pressure control valves, etc.

The control device may be configured to alter the system speed based upon the changing vertical distances (h) and/or changes in contour sensed in anticipation.

In a further embodiment, a first response time for raising the distribution linkage and/or the booms of the distribution linkage upwards may be stored in the control device, and a second response time, shorter than the first response time, for lowering the distribution linkage and/or the booms downwards, may be stored. In this case, the control device may be configured to use either the first or the second response time, depending on whether raising the distribution linkage or lowering the distribution linkage downwards is effected for height control. This embodiment is based on the knowledge that raising the distribution linkage and/or the booms upwards takes longer than lowering them, because of the different forces required in each case (or the pressure build-up required in each case in the actuating cylinders, in the case of fluid-actuated actuating cylinders), due to gravity. Advantageously, the different response times enable this to be taken into account.

An alternative embodiment avoids the need to store fixed response times and/or a fixed system speed. Instead, a time point for the upward driving of the distribution linkage may tend to be effected somewhat earlier than for the downward driving of the distribution linkage. An alternative embodiment therefore provides that the control device is configured to set actuating signals for raising the distribution linkage and/or the booms of the distribution linkage upwards earlier than actuating signals for lowering the distribution linkage and/or the booms downwards in response to the vertical distances and/or changes in contour sensed in anticipation by the sensor device.

In a preferred embodiment, the position control of the distribution linkage comprises a height control of the distribution linkage, in particular a height control of a central part of the distribution linkage, there being lateral booms mounted on the central part. For this purpose, the actuating device comprises an actuating device for adjusting the height of the central part. According to an embodiment variant of this embodiment, the central part is mounted on a carrier vehicle of the agricultural distribution machine so as to be height-adjustable, in a manner known per se, for the purpose of setting its vertical distance relative to an agricultural target area, preferably a crop, to be worked. For the purpose of adjusting the height of the central part, the actuating device may comprise a height-adjustable lifting frame, which is mounted on the carrier vehicle in a height-adjustable manner, for example by means of a parallelogram linkage or a linear slide. For the purpose of height adjustment, there may be, for example, a linear drive in the form of a hydraulic or pneumatic cylinder (as part of the actuating device) assigned to the parallelogram or the linear slide can be assigned, such that the vertical distance between the distribution linkage and a ground surface, or a crop, can be altered in a variable manner.

In a further preferred embodiment, the position control of the distribution linkage comprises a pivoting of the distribution linkage about a pivot axis extending in the direction of travel, preferably a pivoting of a central part of the distribution linkage, on which the lateral booms are mounted, about the pivot axis extending in the direction of travel. For this purpose, the distribution linkage is arranged, either directly or indirectly, on a carrier vehicle of the distribution machine so as to be movable about a pivot axis extending in the direction of travel. According to this embodiment, the actuating device comprises an actuating device by which an actuating force can be generated in order to move the distribution linkage about the pivot axis. For this purpose, the central part may be coupled via this actuating device to a body portion or frame portion and/or to a rigidly or movably mounted support portion of the carrier vehicle. The body portion or frame portion and/or the rigidly or movably mounted support portion may be a carrier frame, e.g. a lifting frame for height adjustment, as has been described above. The pivot axis may further be realized, for example, by a ball joint. The ball joint not only enables pivoting about the pivot axis, but also about a further axis.

It has already been stated above that the position control of the distribution linkage may comprise a height adjustment of the entire distribution linkage, preferably by means of a height adjustment of a central part of the distribution linkage, and/or a pivoting of the distribution linkage, preferably of the central part, about a pivot axis extending in the direction of travel, based upon changing vertical distances sensed in anticipation.

The position control of the distribution linkage based upon changing vertical distances sensed in anticipation may alternatively or additionally comprise a control of the angling of the booms relative to each other and/or the angling of adjacent segments based upon the changing vertical distances sensed in anticipation. This enables the vertical position of the booms and/or their segments to be individually adapted to an - as viewed in the direction of longitudinal extent of the distribution linkage - uneven target area.

Embodiments of this are described below.

Further possible embodiments relate to an agricultural distribution machine, which in turn comprises two lateral booms and a central part, each of which has a plurality of application elements for applying the material. According to these embodiments, the lateral booms are each mounted on the central part of the distribution linkage so as to be pivotable about an axis extending in the direction of travel (hereinafter also referred to as a boom axis).

According to these embodiments, the controllable actuating device for alteration of the position of the distribution linkage relative to the target area comprises actuating elements by means of which the booms can be pivoted about the axes extending in the direction of travel (boom axis). Accordingly, a separate vertical position can be set individually for each boom relative to the target area, e.g. by alteration of its pivot position relative to the central part.

According to an embodiment variant thereof, the booms may further each be composed of two or more segments (which may also be referred to as linkage portions), the segments in turn being pivotable relative to one another about axes extending in the direction of travel (hereinafter also referred to as segment axes). This means that the booms, as viewed in the direction of longitudinal extent of the booms, are each composed of a plurality of segments, for example 2 or 3, connected by joints. Two adjacent segments (linkage portion) connected by joints comprise an inner and an outer segment (linkage portion) with respect to the central part. According to this embodiment, the controllable actuating device additionally comprises actuating elements by means of which the segments can be pivoted about the axes (segment axes) extending in the direction of travel. In other words, such an additional actuating element that can be driven by the control device is in each case assigned to two adjacent segments and/or their joint forming the segment axis. Accordingly, adjacent segments may be angled upwards or downwards in relation to each other in order to set a separate vertical position for the individual segments.

For these embodiment variants, the distribution machine comprises a sensor device and a control device, which may be realized as described above. In this case, for the purpose of controlling the position of the distribution linkage, the control device is preferably configured to generate actuating signals for the actuating device based upon the changing vertical distances sensed in anticipation, in order to at least partially compensate a response time in the position control, the position control of the distribution linkage including a control of the pivot position of the booms about the boom axis and/or of the segments of the booms about the segment axis.

In one embodiment, the sensor device is configured to sense in anticipation, for each of the booms and/or for different segments of each boom (i.e. for all segments or only for some of them) respectively, changing vertical distances with respect to the target area, and/or to sense respectively the vertical distance between the boom and/or the segment and the target area at different measurement locations that spaced apart from each other in the direction of travel.

Alternatively or additionally, the sensor device for anticipatory sensing of respective changing vertical distances of the two booms and/or of different segments of the booms may comprise sensors on each boom, preferably sensors on at least two different segments per boom, and/or for this purpose comprise a plurality of sensors, which - as viewed in the direction of longitudinal extent of the distribution linkage - are arranged at a distance from each other on the distribution linkage. Advantageously, an upcoming change in height may be sensed in anticipation in a boom-specific and/or segment-specific manner.

Alternatively or additionally, the sensor device may comprise, per boom or on at least two segments per boom, respectively at least one close-range sensor arranged on the respective boom or segment, which sensor is configured to sense actual relating to the vertical distance between the distribution linkage and the target area and/or to scan an actual contour of the target area, and may further comprise at least one far-range sensor arranged on the respective boom or segment, which sensor is configured to sense upcoming relating to the vertical distance and/or to scan an upcoming contour of the target area.

This offers the advantage that both an actual vertical distance (by means of the close-range sensor) and an upcoming change in height may be sensed in anticipation in a boom-specific manner or also for individual segments, which accordingly enables rapid but also precise position control with regard to vertical distances. According to these embodiments, the sensor device thus comprises a plurality of pairs of respectively one close-range sensor and one far-range sensor, which are arranged at a distance from each other as viewed in the direction of longitudinal extent of the distribution linkage. At least one such pair may be arranged on each boom. A plurality of such pairs may also be arranged on each boom, for example one such pair may be arranged on at least two segments of each boom. Furthermore, respectively one close-range sensor and one far-range sensor may be arranged at the same point on the distribution linkage, one above the other or next to one another.

The far-range sensors and close-range sensors may be realized as described above. In this respect, reference is made to the explanations given above.

Alternatively or additionally, for travel along curves, and preferably upon a predetermined travel speed being exceeded, the control device may be configured to use its at least one close-range sensor for controlling the height of the boom located on the inside of the curve, and to use its at least one far-range sensor for controlling the height of the boom located on the outside of the curve.

It has already been stated above that the position control of the distribution linkage may optionally include a control of segments of the booms about the segment axes extending in the direction of travel, preferably for the purpose of individually adapting a vertical distance of the segments to an - as viewed in the direction of longitudinal extent of the distribution linkage - uneven target area. In a possible embodiment thereof, a first response time for angling segments of the booms of the distribution linkage upwards may be stored in the control device, and a second response time, shorter than the first response time, may be stored for angling segments of booms of the distribution linkage downwards. Due to gravity, the response takes longer when the segments are being angled upwards than when they are being angled downwards.

A further alternative embodiment avoids the need to store fixed response times. Instead, a time point for angling segments of the booms upwards may tend to be effected somewhat earlier than for angling segments downwards. An alternative embodiment therefore provides that the control device is configured to set actuating signals for an upward angling of segments of the boom of the distribution linkage earlier, in response to the vertical distances and/or contour changes sensed in anticipation by the sensor device, compared to actuating signals for a downward angling of segments of the boom of the distribution linkage.

For example, the control device may be configured to use either the first or the second response time to adapt the timing of the actuating device, depending on whether an upward or downward angling of segments of the distribution linkage is being effected in the course of the height control. These different response times do not necessarily have to be explicitly stored as a time variable in the control device, but may also be implicitly incorporated in the control algorithms.

The sensor device according to the invention may, as described above, be used for angling the booms relative to each other, in order thus to enable the booms also to be angled proactively relative to each other. Further embodiments of this are described below.

Preferably, angular position transducers and/or a displacement measuring system in the hydraulic cylinder may be assigned to the segments of the booms for the purpose of sensing and transmitting an actual value with regard to the relative position of respectively adjacent segments. The segments may be connected to each other by means of joints, and an actuating movement of the individual segments relative to each other may be actively controllable by the control device, there being a controllable actuator respectively assigned to each of the joints between the segments, i.e. two adjacent segments.

Furthermore, the control device may be configured to generate the actuating signals for the actuating elements based upon the signals of the sensor device and the angular position transducers, whereby an actuating movement of a segment always being effected in relation to the other segments of a boom. In this case, an alteration of the relative position of a first segment may preferably be effected simultaneously with the alteration in the opposite direction of the relative position of at least one second segment that is arranged on the same boom, as a result of which the actuating movement of the outer segments is effected in relation to the respective inner segment arranged thereon.

The driving of the actuating elements of the actuating movement of a segment always in relation to the other segments of a boom may be effected, in particular, as described in the published patent application EP 2 186 405 A1. The respective aspects concerning the adjustment of the segments in relation to the other segments are hereby incorporated into the present disclosure with reference to this published patent application.

It has already been stated above that two adjacent segments of a boom connected by joints comprise an inner and outer segment with respect to the central part. In a further embodiment variant, the control device may be configured to generate the actuating signals for the actuating elements based upon the signals of the sensor device and the angular position transducers, an angling of the outer segment of a boom being performed, e.g. pre-controlled, based upon an angling of the inner segment of a boom, in such a manner that the angling of the outer segment is coupled to the angling of the inner segment.

This pre-control of the angling of the outer segment based upon an angling of the inner segment of a boom may in particular be effected as described in the published patent application EP 2 186 405 A1. The respective aspects concerning the coupled angling of the inner and outer segments are hereby incorporated into the present disclosure with reference to this published patent application.

The actuating device may have pneumatic or hydraulic actuating cylinders as actuating elements, e.g. for adjusting the height of the central part, for pivoting the central part about the axis extending in the direction of travel, for pivoting the booms about the boom axis and/or for pivoting the segments about the segment axis(axes) assigned to them.

In order to reduce the response time, or to increase the system speed in controlling the position of the distribution linkage, it would also be conceivable for the driving to be embodied accordingly, and thus, for example, the effective cross-sections of the actuating cylinders of a fluidically actuatable actuating device are adapted and/or can be adapted.

Preferably, the term “control device” may relate to electronics (e.g. in the form of a driver circuit or having microprocessor(s) and data store) and/or to a mechanical, pneumatic and/or hydraulic control, which, depending on the design, may perform open-loop control tasks and/or closed-loop control tasks and/or processing tasks. Even if the term “control” is used herein, this may also equally include or mean “closed-loop control” or “control with feedback” and/or “processing”.

The distribution machine may be a self-propelled distribution machine or a distribution machine towed by a towing vehicle or attached to a towing vehicle. The self-propelled distribution machine may furthermore be an autonomously travelling agricultural machine, for example a fully autonomously or partially autonomously travelling agricultural machine. The distribution linkage has a wide working width, i.e. a working width substantially greater than a width of the carrier vehicle, e.g. a multiple of the width of the carrier vehicle. Furthermore, the two lateral booms of the distribution machine and/or the segments of the booms may each be rotatably connected, via a vertical pivot axis, to a central part of the spray linkage for the purpose of folding in and out, from a transport position in the folded-in state to a working position in the folded-out state.

In a manner known per se, the distribution machine may further comprise a sensor system for sensing a rotational position and/or a rotational speed and/or an acceleration of the distribution linkage. In a manner known per se, the distribution machine may further comprise a sensor system for sensing actuating forces and/or actuating or relative movements between the central part of the distribution linkage and the interfacing on the carrier vehicle, e.g. the support, body or frame portion on the carrier vehicle. For an example of an embodiment of such sensor systems and their use in controlling the rotational position of the distribution linkage about the central pivot axis of the central part, reference is made to the published patent applications EP 2 591 657 A1, WO 2015/040133 A1, WO 2015/055680 A1, WO 2015/067804 A1, DE 10 2019 123 113 A1, the aspects thereof concerning the sensor systems and their use in controlling the rotational position of the distribution linkage about the central pivot axis of the central part being hereby incorporated in this disclosure with reference to these published patent applications. The sensor system may include, for example, a rotation rate sensor for sensing the rotational speed of the distribution linkage about the pivot axis, a rotational position sensor for sensing the rotational position of the distribution linkage about the pivot axis, an acceleration sensor for sensing an acceleration of the distribution linkage, a pressure sensor system for sensing the aforementioned actuating forces and/or actuating or relative movements, and/or pressure control valves for correcting the aforementioned actuating forces and/or actuating, or relative, movements.

According to a second general aspect, a method is provided for controlling the position of a distribution linkage of an agricultural distribution machine. The method in this case comprises the step of anticipatory sensing, by a sensor device, of changing vertical distances between the distribution linkage and the target area to be worked. The method further comprises, based upon the changing vertical distances sensed in anticipation, generating actuating signals for an actuating device for the purpose altering a position of the distribution linkage relative to the target area, a response time in the position control of the distribution linkage being at least partially compensated in that the actuating signals are generated before the distribution linkage reaches the changing vertical distances.

The method for controlling the position of the distribution linkage based upon changing vertical distances sensed in anticipation may, as already stated, be a method for controlling the height of the distribution linkage, e.g. comprise a method for adjusting the height of the entire distribution linkage, preferably on the basis of a height adjustment of a central part of the distribution linkage. Alternatively or additionally, the method for controlling the position of the distribution linkage may comprise pivoting the distribution linkage, preferably the central part, about a pivot axis extending in the direction of travel. Alternatively or additionally, the method for controlling the position of the distribution linkage may include controlling the height of the booms on the basis of controlling of the angling of the booms relative to each other and/or of the angling of adjacent segments relative to each other.

In order to avoid repetition, features disclosed purely with reference to a device are also to be regarded as disclosed with reference to a method, and are also to be regarded as claimable with reference to the method. The aforementioned aspects and features according to the invention, in particular with regard to the design of the distribution machine, in particular the sensor device, the actuating device and the control device, thus also apply to the method.

### BRIEF DESCRIPTION OF THE DRAWINGS

The preferred embodiments and features of the invention described above can be combined with one another in any manner. Further details and advantages of the invention are described below with reference to the accompanying drawings. In the drawings:

FIG. 1A shows a schematic perspective view of a distribution machine, according to an embodiment of the invention;

FIG. 1B shows a schematic rear view of the distribution machine from FIG. 1A;

FIG. 2 shows an illustration of sensing of changing vertical distances by means of a close-range and a far-range sensor, according to an embodiment of the invention;

FIGS. 3A, 3B and 4 show schematic block diagrams to illustrate controlling of the position of the distribution linkage, according to embodiments of the invention;

FIGS. 5 and 6 each show an illustration of sensing of changing vertical distances by means of a close-range and a far-range sensor, according to an embodiment of the invention;

FIG. 7A shows a schematic perspective view of a distribution machine, according to an embodiment of the invention;

FIG. 7B shows a schematic rear view of the distribution machine from FIG. 7A;

FIG. 8A shows a schematic side view of a distribution machine, according to an embodiment of the invention;

FIG. 8B shows a schematic detail view from behind the distribution machine from FIG. 8A;

FIG. 9A shows a schematic rear view of the distribution machine, according to an embodiment of the invention; and

FIG. 9B shows a schematic detail view of two adjacent segments of a boom that can be pivoted relative to one another, according to an embodiment of the invention.

### DETAILED DESCRIPTION OF THE PREFERRED EMBODIMENTS

In the figures, elements that are the same or functionally equivalent are in some cases denoted by the same references, and in some cases not described separately.

The distribution machine 1 is in the form, for example, of a trailed field sprayer, i.e. as an agricultural field sprayer that can be coupled, or trailed, by means of a towing vehicle. The direction of travel is indicated by the arrow V. The direction of longitudinal extent of the distribution linkage is indicated by the arrow L.

The distribution machine 1 has a distribution linkage 2 mounted, directly or indirectly on a carrier vehicle 5, for applying material such as fertiliser, plant protectant or seed. In the case of a field sprayer, the material to be applied is a spray liquid. The distribution linkage 2 comprises two lateral booms 3, which are fastened in a pivotable manner at their inner end to a central part 4 and have an outer free end. The distribution linkage 2 in this case may have, for example, a working width of more than 20 metres. The distribution linkage 2, or the booms 3, may be formed, at least in sections, by a truss-like linkage structure, or by a truss construction. Furthermore, the linkage structure, or the truss construction, is of a greater height than depth.

The two lateral booms 3 and the central part 4 each have a plurality of application elements for applying the material, e.g. spray nozzles arranged at intervals in the direction of longitudinal extent of the distribution linkage.

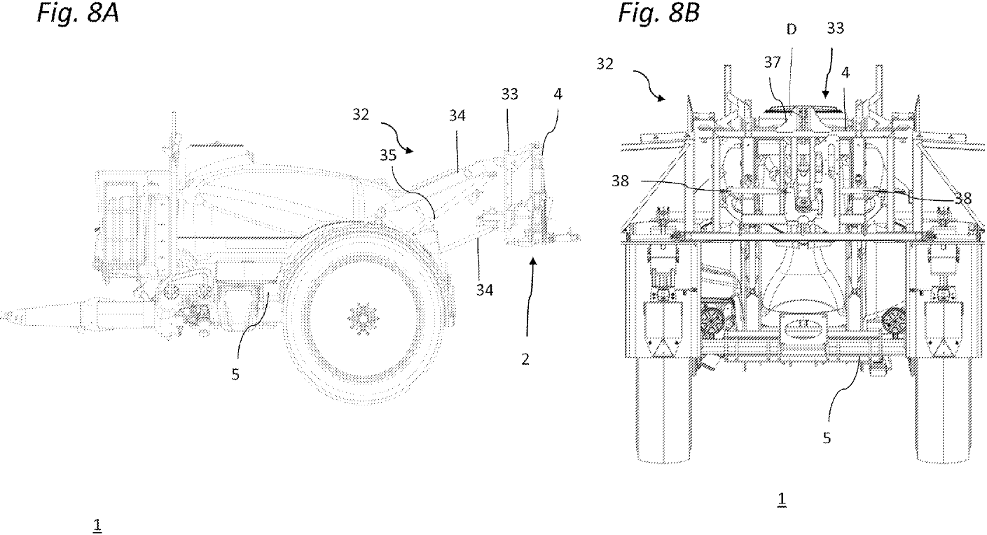

For the purpose of setting its vertical distance relative to an agricultural target area Z to be worked, the central part 4 is mounted on the carrier vehicle 5 so as to be adjustable in height by means of an actuating device 32 for adjusting the height of the central part 4. For this purpose, the actuating device 32 for adjusting the height of the central part 4 comprises a height-adjustable lifting frame 33 on which the central part 4 is mounted. The lifting frame 33 is mounted on the carrier vehicle 5 in a height-adjustable manner by means of a parallelogram linkage 34, in a manner known per se. The actuating device 32 for adjusting the height of the central part 4 also comprises two fluidically actuated actuating cylinders 35, which are supported at one end on the carrier vehicle 5 and at the other end on the lifting frame 33. The actuating device 32 can thus be used to raise and lower the entire distribution linkage for the purpose of height control. The actuating device 32 is also represented more clearly in FIG. 8A.

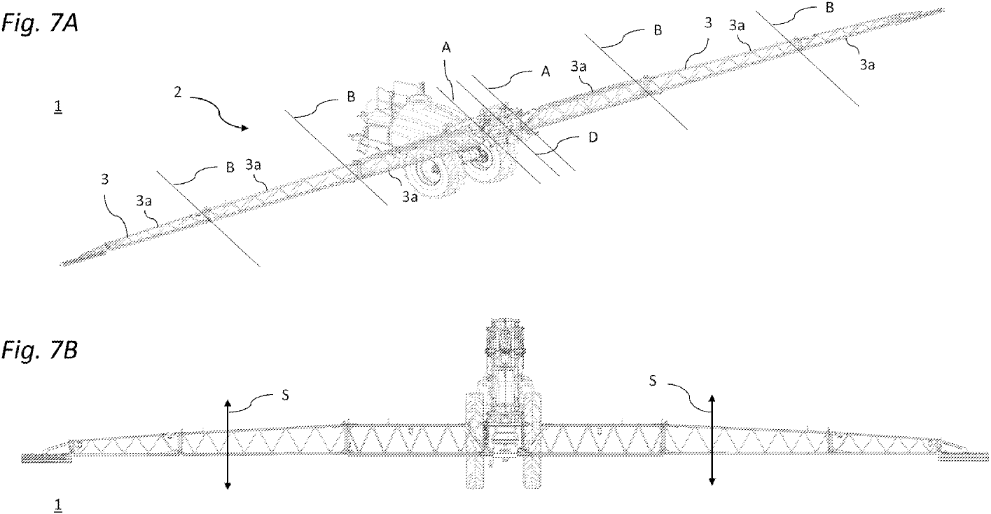

For the purpose of controlling the position of the distribution linkage 2, the distribution linkage, the booms 3 and, optionally, also individual segments of the booms 3 can be pivoted about horizontal axes extending in the direction of travel V, which is known per se from the prior art and will be explained in more detail below in connection with FIGS. 7A to 9B.

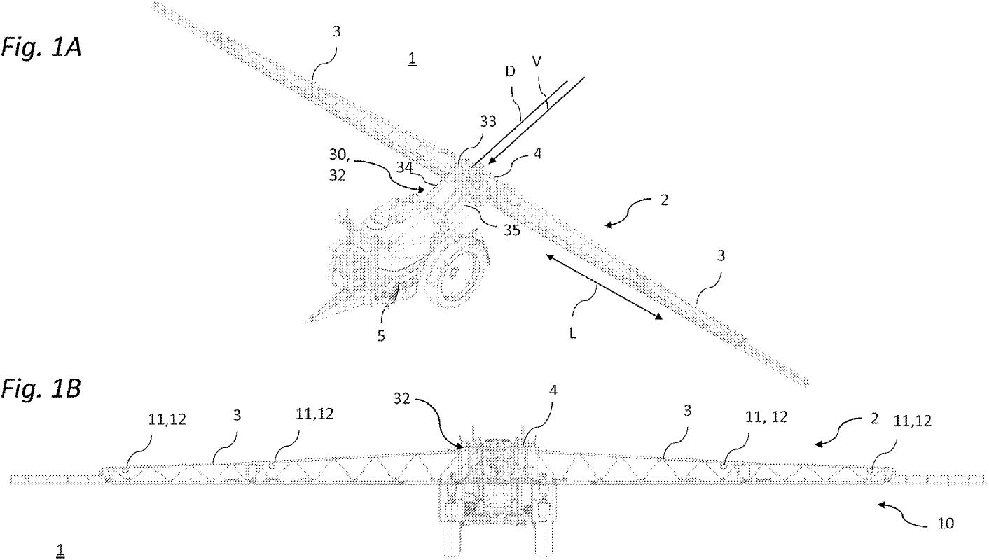

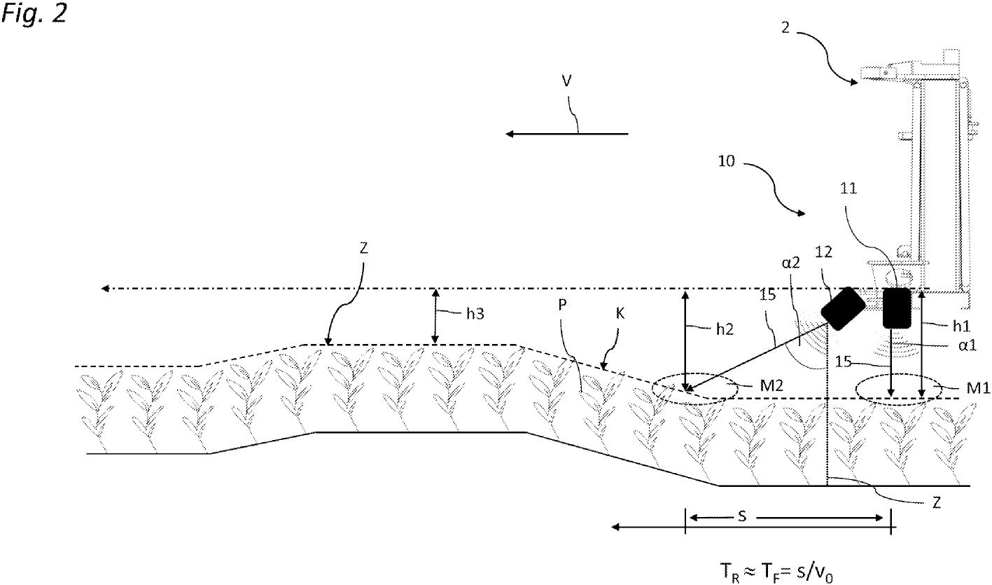

As represented in FIG. 1B and FIG. 2, the distribution machine 1 has a sensor device 10. The sensor device is is configured to sense in anticipation changing vertical distances between the distribution linkage 2 and the target area Z. For this purpose, the sensor device 10 comprises respectively one close-range sensor 11 and one far-range sensor 12 on two of three segments of each boom 3. Alternatively, there may also be only one pair, of a close-range sensor 11 and a far-range sensor 12, arranged for the entire distribution linkage 2 or for each boom 3, or there may be a pair, of a close-range sensor and a far-range sensor 12, arranged on each segment of the boom 3.

Shown in detail in FIG. 2 is an illustration of sensing of changing vertical distances h by means of a close-range and a far-range sensor, according to an embodiment of the invention. For greater clarity, only the distribution linkage 2 is represented in a side view in FIG. 2, but neither the actuating device by which the position of the distribution linkage can be altered nor the carrier vehicle 5 are shown. As can be seen in FIG. 2, the upcoming vertical distance h of the distribution linkage may change along the direction of travel V if the distribution linkage were to maintain its current vertical position.

The vertical distance h here corresponds to a distance between the underside of the distribution linkage 2 and a target area Z, in this case a crop P. The vertical distance changes here, for example starting from h1 to h2, h3 etc., because the contour K of the target area changes in the direction of travel.

During application, the distance between the distribution linkage and the ground or the crop during travel should remain as constant as possible in the direction of travel.

The sensor device 10 comprises a close-range sensor 11, which is configured to sense actual values h1 for the vertical distance between the distribution linkage and the target area at a first measurement region (measurement region) M1, and/or to sense an actual contour of the target area.

The sensor device 10, which is configured to sense in anticipation changing vertical distances h between the distribution linkage 2 and the target area Z, further comprises for this purpose a far-range sensor 11, which is configured to sense upcoming values h2 for the vertical distance at a second measurement location (measurement region) M2, and/or to scan an upcoming contour of the target area, the second measurement location M2 - as viewed in the direction of travel V -being located several metres ahead of the first measurement region M1.

The close-range sensor 11 and the far-range sensor 12 are each in the form of ultrasonic sensors. Compared to the close-range sensor 11, however, the far-range sensor 12 has a direction of view that is oriented further forward onto the target area.

The close-range sensor 11 has a downwardly oriented direction of view 15 that forms with a vertical Z an angle α1 that is in the range of from 0° to 15°. The far-range sensor 12, on the other hand, has an obliquely forward-oriented direction of view 15 that, compared to the direction of view of the close-range sensor, is directed further forward. The direction of view of the far-range sensor 12 may form with a vertical an angle α2 that is in a range of from 5° and 90° or in a range of 15° to 70° with respect to the vertical Z. The angle α1 to the vertical Z is thus smaller than α2. In the example shown in FIG. 2, the angle α2 has the value 45°, merely as an example.

Thus, the first measurement location M1 corresponds to a close range beneath or obliquely in front of the distribution linkage 2. The first measurement location M1 may include measurement points of a range that - as viewed in the direction of travel V - is at a distance in the range of from zero metres to one metre from the distribution linkage 2. The second measurement location M2, on the other hand, corresponds to a far range that - as viewed in the direction of travel V - is located ahead of the close range. The second measurement location M2 may include measurement points of a range that - as viewed in the direction of travel (V) -is at a distance in a range of from one to 50 metres, preferably in a range of from one to 10 metres, from the distribution linkage 2.

The actual vertical distance h1 can be sensed relatively accurately by means of the close-range sensor 11. However, if this sensor 11 detects a changed vertical distance, to which a response required so that the desired vertical distance between the distribution linkage and the target area Z can be maintained, this adaptation of the vertical distance may not be effected in time.

The reason is the technical response time T_{R} that is needed to set the new linkage position. The response time T_{R} is specific to each distribution machine and is influenced, for example, by the comparatively high mass inertia of the linkage, the response time of the hydraulics and the time taken to process the sensor data. At a travel speed v₀, the linkage covers the distance s= v₀* T_{R} in this time T_{R}.

With the present sensor device 10, changing vertical distances h between the distribution linkage 2 and the target area Z may be sensed in anticipation, or predicted, by device of the far-range sensor 12. The anticipatory sensing of changing vertical distances allows actuating signals to be generated for adaptation to these changing vertical distances before the distribution linkage 2 reaches a changed vertical distance. Accordingly, the response time for this adaptation can be at least partially compensated.

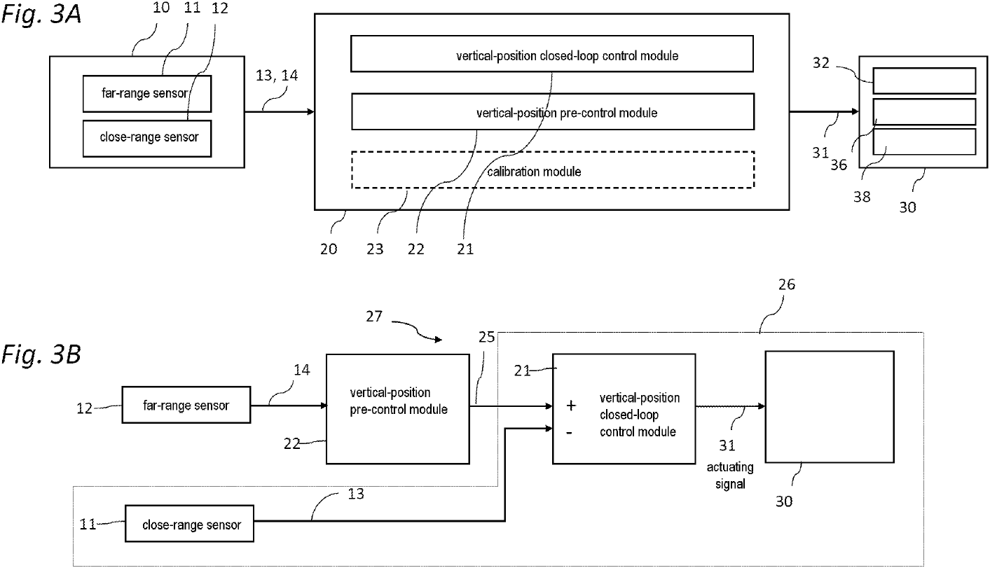

An example of such a position control is explained in FIGS. 3A and 3B, which illustrate a position control of the distribution linkage, according to one embodiment of the invention.

The distribution machine 1 comprises a control device 20, which is configured to generate actuating signals 31 for the actuating device 30 based upon the changing vertical distances sensed in anticipation for the purpose of controlling the position, preferably controlling the height, of the distribution linkage 2 in order to at least partially compensate a response time in the position control. For this purpose, the control device 10 receives, on the input side, measurement data 14 from the second measurement location M2 and the far-range sensor 12, and measurement data 13 from the first measurement location M1 and the close-range sensor 11, i.e. measurement data 13 relating to the actual vertical distance h1 and measurement data 14 relating to the upcoming vertical distance h2.

The actuating device 30 may be, for example, an actuating device 32 for adjusting the height of the central part 4. This is the case if the control of the position of the distribution linkage 2 corresponds to a control of the height of the distribution linkage 2 by means of an adjustment of the height of the central part 4.

This embodiment makes use of the fact that at the first measurement location M1 vertical distance data are sensed accurately, but too late to compensate the response time, whereas at the second measurement location M height distance data can be sensed less accurately but with anticipation, such that it is possible to respond at an early stage to changing vertical distance data. The use of vertical distance data from both measurement locations M1, M2 in combination allows rapid and particularly accurate position control of the distribution linkage in response to changing vertical distances between the distribution linkage 2 and the target area Z.

Although the measurement of vertical distance by means of the far-range sensor 12 is less accurate due to the oblique direction of view 15, in practice, however, it is nevertheless sufficient to detect whether the vertical distance remains the same, decreases or increases in comparison with the current vertical distance, such that a correction of the vertical position can be initiated even at an early stage. For this purpose, the control device 20 may comprise a vertical-position pre-control module 22 providing this functionality.

A precise adjustment may then subsequently be effected on the basis of measurement values of the close-range sensor 11. For this purpose, the control device 2 may comprise a vertical-position closed-loop control module 21 providing this functionality.

As illustrated in FIG. 3B, the control device 20, in particular the vertical-position pre-control module 22, is configured to determine in anticipation, based upon the measurement values 14 sensed by the far-range sensor 12, a change in vertical distance, or a variable derived therefrom, that indicates whether the vertical distance between the distribution linkage 2 and the target area Z remains the same, decreases or increases in comparison with the current vertical distance. Based upon this, a new setpoint vertical position 25 is determined. If no upcoming change in height is detected on the basis of the far-range sensor data, or at least none that is greater than a threshold value, the value for the setpoint vertical position remains unchanged. The setpoint vertical position 25 is transmitted to the vertical-position closed-loop control module 21.

The control device 20, preferably the closed-loop control module 21, is configured to determine a deviation of the actual vertical distance h1, between the distribution linkage and the target area Z, from the setpoint vertical distance 25 based upon the measurement values 13 sensed by the close-range sensor 11, and in dependence thereon to generate actuating signals 31 for the actuating device 30 for the purpose of adjusting the actual vertical distance to the setpoint vertical distance.

Thus, if no change in the vertical distance is predicted by means of the far-range sensor 12, the setpoint vertical distance remains the same and is continuously monitored and adjusted by the height closed-loop control module 21. This corresponds to a first operating mode 26, in which the vertical distance of the distribution linkage 2 is adjusted to a setpoint vertical distance based upon the measurement values 13 sensed at the first measurement location.

However, as soon as a (minimum) change in the vertical distance is predicted on the basis of the measurement data 14 of the far-range sensor 12, a change is made to a second operating mode 27, in which actuating signals for the anticipatory alteration of the position of the distribution linkage 2 are generated based upon the changing vertical distances sensed in anticipation at the second measurement location M2, which actuating signals cause a current position of the distribution linkage 2 to be adapted to the changing vertical distances, before the second measurement location M2 is reached.

The control device 20 may further be configured to check and calibrate measurement data 14 of the less accurate far-range sensor 12 at a time point t on the basis of measurement data 13 of the more accurate close-range sensor 11, where t+x corresponds to the time at which the first measurement location M1 reaches the location of the second measurement location M2 in the current travel operation. If, for example, the check reveals a deviation of a vertical distance determined by means of the measurement data of the far-range sensor at time point t from a vertical distance determined by means of the measurement data of the close-range sensor 11 at the time point t+x, this deviation is used as an offset or correction value for the measurement data of the far-range sensor 12. The offset or correction value may be adapted continuously. This functionality may be provided by an optional calibration module 23.

Furthermore, the control device 21 may optionally be configured to factor out in the height control a deviation of the distribution linkage from a setpoint position, caused by an oscillation of the distribution linkage 2, preferably in such a manner that vertical oscillations S and/or horizontal oscillations of the distribution linkage do not affect the determination of the vertical distance of the distribution linkage and/or the height control.

Due to the wide working width of distribution linkages, it is known that disturbing vertical oscillations and/or horizontal oscillations of the distribution linkage may occur, in which the free ends of the booms swing back and forth. Such oscillations may be sensed by sensors, e.g. acceleration sensors arranged on the distribution linkage, and/or by the close-range sensor 11. The oscillations sensed in this way constitute a disturbing influence upon the measurement of the vertical distance. Vertical oscillations result in upward or downward deviations from the average vertical position of the distribution linkage. Horizontal oscillations result in forward or rearward deviations from the average position in the direction of travel of the distribution linkage. The control device may be configured to factor out these effects computationally on the basis of the oscillations sensed by the sensors. Accordingly, more accurate sensing of vertical distances and improved position control can be achieved. Examples of such vertical oscillations are illustrated by the double arrows s in FIG. 7B.

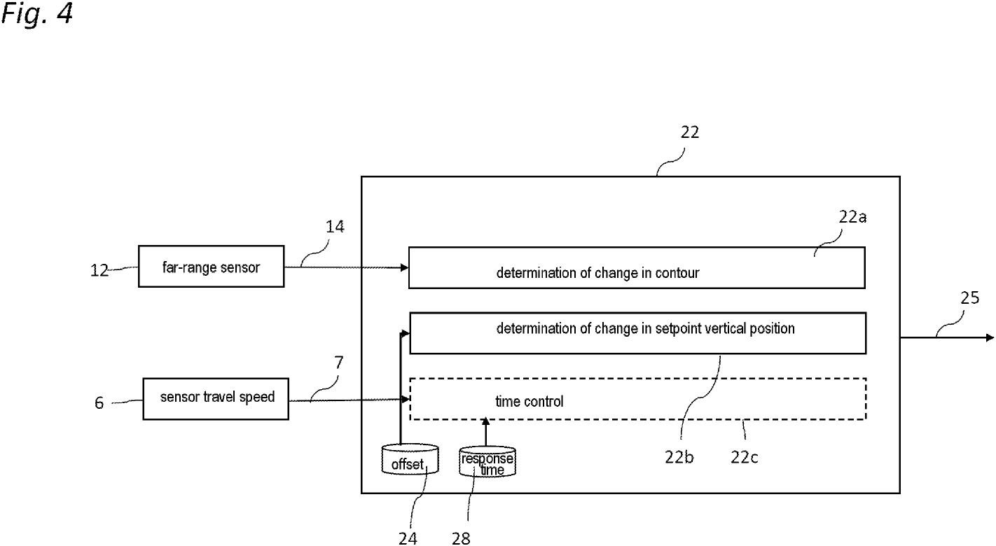

FIG. 4 shows a schematic block diagrams to illustrate controlling of the position of the distribution linkage, according to a further embodiment variant. This functionality may be implemented, for example, in the vertical-position pre-control module 22.

For example, the control device 20, e.g. of the vertical position pre-control module 22, may be configured to determine in anticipation, based upon the measurement values sensed at the second measurement location (M2), a change in contour of the target area, i.e. a change in vertical distance or a variable derived therefrom (cf. module 22a), that indicates only whether the vertical distance between the distribution linkage and the target area remains the same, decreases or increases in comparison with the current vertical distance. Even if the measurement by means of the far-range sensor 12 is less accurate than with the close-range sensor 11, it can still be reliably established whether the vertical distance between the distribution linkage and the target area at the second measurement location M2 will remain the same, decrease or increase in comparison with the current vertical distance. This means that it can be predicted whether the vertical distance will change and if so, in which direction. For example, the change in vertical distance or the variable derived therefrom may be determined as a gradient of the vertical distance between the distribution linkage 2 and the target area Z, with optionally only a direction of the gradient and not a magnitude of the gradient being determined.

Before the distribution linkage 2 reaches the second measurement location M2, an actuating signal 31 is generated for the actuating device 30 based upon the determined change in vertical distance, or the variable derived therefrom, for the purpose of adapting the position of the distribution linkage 2 to the change in vertical distance. For an advantageous implementation, the vertical position pre-control module 22 may be configured to adapt the setpoint vertical position by an offset value 24 based upon the determined change in vertical distance, or the variable derived therefrom, such that there is generated in response thereto an actuating signal 31 that causes the position of the distribution linkage 2 to be altered, by the offset value 24 (cf. module 22b), relative to the agricultural target area Z to be worked. If, for example, the current setpoint vertical position is set to 50 cm, an offset value of, for example, 5 or 10 cm may be selected. If in this case an increase in the vertical distance is detected in anticipation, the current setpoint vertical distance is briefly reduced by 5 or 10 cm in anticipation. The setpoint vertical position can then be reset to 50 cm, e.g. after the second measurement location M2 has been reach, such that the closed-loop control module 21 can perform a more precise adjustment based on the close-range sensor 11.

It is also optionally possible to store a plurality of offset values 24 in advance, in order to select one of the stored offset values based upon the sensed change in vertical distance. The offset values can thus be used to realize a discrete pre-control in order to adapt the position of the distribution linkage to predicted changes in height. The anticipatory adaptation by means of an offset value is therefore not directly proportional to the sensed upcoming change in vertical distance, but it is nevertheless rapid and robust.

In a further variant, the control device 20 is configured to determine a time point for the generation of an actuating signal 31 for at least partial compensation of the response time in the position control based upon the travel speed 7 and/or a linkage speed in the direction of travel. The time point is approximately determined in such a way that a travel time remaining after the time point until the second measurement location M2 is reached substantially corresponds to the response time. For this purpose, the response time 28 may be stored in the control device 20, e.g. in a data store. This functionality may be realized by an optional timing module 22c. The travel speed 7 may be provided by an ordinary travel-speed sensor 6.

With the present sensor device 10, however, changing vertical distances h1, h2, h3 between the distribution linkage 2 and the target area Z can be sensed in anticipation, or predicted, by use of the far-range sensor 12. The time point for the generation of an actuating signal 31 is in this case preferably selected in such a way that it anticipates to such an extent that the travel time T_{F} at the current travel speed v0 up to the point at which the adaptation of the linkage position is completed substantially corresponds to the response time T_{R}, i.e. T_{R} ≈ T_{F}= s/v₀ (cf. FIG. 2). The time point for the generation of an actuating signal 31 may be effected approximately by determination of the time point at which the vertical-position pre-control module adapts the setpoint vertical position 25 to the vertical distance sensed in anticipation. At slow travel speeds, the time point may thus be delayed so that the height adjustment is not effected too early.

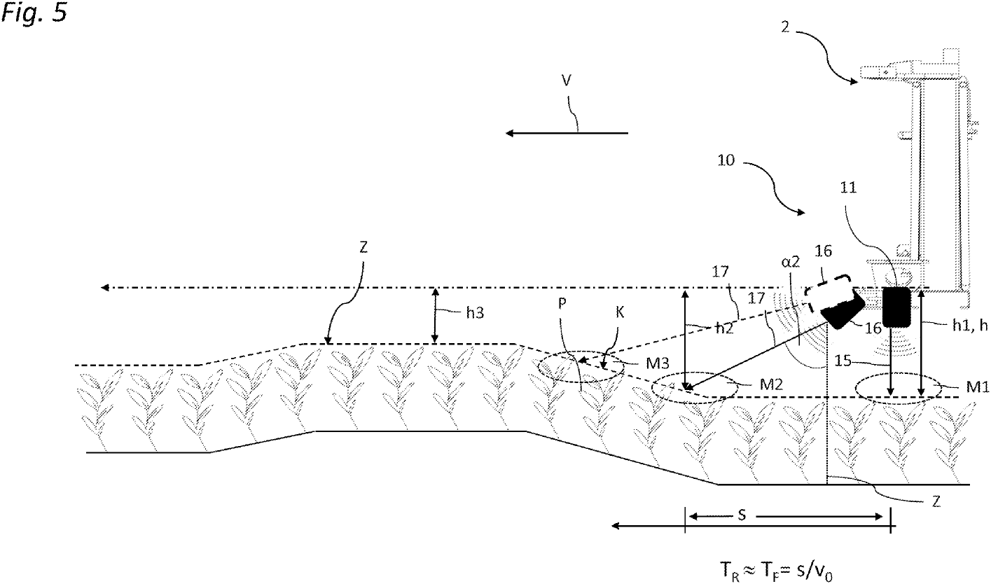

FIG. 5 illustrates a further exemplary embodiment of sensing of changing vertical distances by means of a close-range and a far-range sensor.

The special feature of this exemplary embodiment is that a direction of view of the far-range sensor 16, which is again in the form of an ultrasonic sensor, can be altered for the purpose of altering the position of the second measurement location M2. For the purpose of altering the direction of view, the far-range sensor 16 is arranged in a pivotable manner on the distribution linkage 2. The far-range sensor 16 may be such that it can be driven by the control device 20 for the purpose of altering its pivot position, and thus its direction of view 17. The pivoting may be effected by an actuator that can be driven accordingly by the control device 20, e.g. one that can be actuated electrically (not represented).

FIG. 5 shows the far-range sensor in a first pivot position in which the direction of view 17 is directed towards the measurement location M2. A dashed line in FIG. 5 shows a further possible pivot position in which the far-range sensor has a direction of view 17 that is directed further forward, in this case onto the measurement location M3. In the second pivot position, the angle α2 of the direction of view 17 to the vertical Z is greater than in the first pivot position.

The control device 20 may be configured to alter the direction of view of the far-range sensor 16 based upon the travel speed or a variable derived therefrom, in such a manner that, as the travel speed increases, the direction of view 17 is altered to be further forwards. Particularly advantageous is an embodiment in which the direction of view 17 of the far-range sensor 16 is dynamically directed onto an upcoming measurement location at such a distance ahead of the distribution linkage that a travel time required, on the basis of the current travel speed, until the distribution linkage reaches this measurement location substantially corresponds to the response time or to a variable derived therefrom. If, for example, the response time is 0.5 s, then, as it were, a travel time of 0.5 s is viewed ahead. Thus, as it were, a real-time measurement of the vertical position / vertical distance is made possible at the point at which control of the vertical position is effected.

In other words, the second measurement location M2 and/or the direction of view 17 of the far-range sensor 12 are/is preferably selected in such a way that they/it anticipate/s to such an extent that the travel time T_{F} at the current travel speed v0 up to the point at which the adaptation of the linkage position is completed substantially corresponds to the response time T_{R}, i.e. T_{R} ≈ T_{F}= s/v₀.

Alternatively or additionally, the pivot position 16, and thus the direction of view 17, may also be manually adjustable, e.g. by an operation in which the sensor is adapted in advance to the anticipated travel speed. The further aspects concerning the embodiment variant of FIG. 5 may correspond to those described in FIGS. 2 to 3B, so that reference is made thereto.

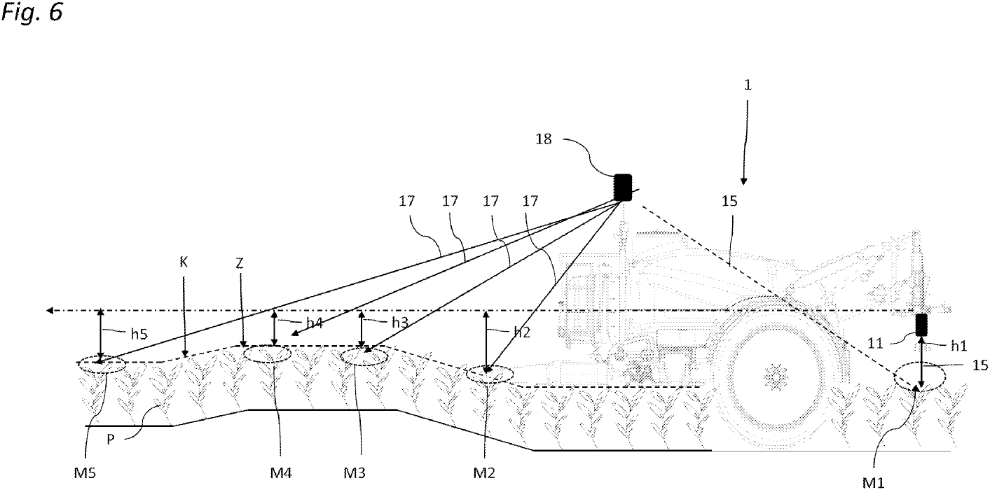

FIG. 6 illustrates a further exemplary embodiment of sensing of changing vertical distances by means of a close-range and a far-range sensor.

The special feature of this exemplary embodiment is that the far-range sensor is now realized as a radar sensor 18. The radar sensor is configured to simultaneously measure the vertical distance between the distribution linkage 2 and the target area Z at a plurality of measurement locations M2, M3, M4, M5, which are spaced apart from each other in the direction of travel. For example, the control device 20 may be configured to select one measurement location from the plurality of measurement locations M2, M3, M4, M5 based upon the travel speed or a variable derived therefrom. At slow travel speeds, for example, the measurement location M2 may be used as the closest measurement location ahead in the direction of travel. The closer the measurement location, the more accurately can the height profile be determined. With increasing travel speed, the response time for adaptation of the linkage position is no longer sufficient, such that measurement location M3, M4 or M5 that is further ahead is expediently selected.

Here, the radar sensor 18 is arranged on the carrier vehicle. However, the radar sensor may also be arranged on the distribution linkage, e.g. at a location above the close-range sensor 11. The further aspects of this embodiment variant may correspond to those described in FIGS. 2 to 3B.

In a further embodiment variant, the radar sensor 18 may additionally be used as a close-range sensor if one of its measurement locations is directed onto the region M1 beneath the distribution linkage 2, this being represented by the dashed line 15 in FIG. 6. In this case, there may optionally not be any separate close-range sensor 11. In this case, it is also particularly advantageous to arrange the radar sensor directly on the distribution linkage 2, e.g. on an upper region of the distribution linkage.

Further application examples and embodiment variants are described below with reference to FIGS. 7A to 9B.

The present technique for anticipatory sensing of changing vertical distances of the distribution linkage may be used for different position controls of the distribution linkage if the control of the position of the linkage depends on a measurement of distance between it and the target area, e.g. the crop.

An example of this is the height adjustment of the entire distribution linkage, preferably by means of a height adjustment of a central part of the distribution linkage. The actuating device 30 in this case is the actuating device 32 as described in FIG. 1. Another example is the pivoting of the distribution linkage or parts thereof about pivot axes extending in the direction of travel.

FIG. 7A shows a schematic perspective view of a distribution machine according to an embodiment of the invention, to illustrate the possible pivot axes.

The present technique for anticipatory sensing of changing vertical distances of the distribution linkage may be applied for controlling the pivot position of the distribution linkage 2, preferably the central part, about a pivot axis D extending in the direction of travel, as illustrated in FIG. 7A. Another example is the pivoting, e.g. angling, of the booms 3 relative to each other about the boom axis A, which likewise extends in the direction of travel. Another example is the angling of adjacent segments 3a of the booms 3 about segment axes B extending in the direction of travel.

According to the embodiment shown in FIG. 7A, the distribution linkage 2 is arranged, either directly or indirectly, on a carrier vehicle 5 of the distribution machine 2 so as to be movable about a pivot axis D extending in the direction of travel. The pivoting of the distribution linkage 2 about the pivot axis D is effected by means of a pivoting of the central part 4 about the pivot axis D extending in the direction of travel. A further actuating device is provided for this purpose, by means of which an actuating force can be generated in order to move the distribution linkage 2 about the pivot axis D. Such pivoting means for pivoting the central part 4 about the axis D are known per se from the prior art. The pivoting device may be configured, for example, as described in the published patent applications DE 20 2007 011 631 U1, EP 2 591 657 A1, or WO 2015/040133 A1 and for this purpose comprise, for example, one double-acting or two single-acting actuating cylinders that can be actuated fluidically.

A possible example is represented in FIG. 8B. FIG. 8B shows a detail view of a central portion 4 of the distribution linkage 2 according to a possible embodiment. The distribution linkage 2 is mounted on a support frame of the distribution machine via a pivot frame. The support structure may be, for example, a height-adjustable lifting frame 33 for altering the vertical position of the distribution linkage (see FIG. 8A).

The pivot frame comprises a horizontal beam, as well as a ball joint mount that is fastened to the horizontal beam and mounted on the support structure via a ball joint (not represented) in the region of the pivot axis D. The ball joint mount 37 is only exemplarily designed in the form of two symmetrical wing-shaped retaining plates. In the present case, the ball-joint mount 37, merely by way of example, is in the form of two symmetrical wing-shaped retaining plates. The ball joint enables the distribution linkage 20 to be pivoted about a pivot axis D extending in the direction of travel, as well as about a vertical axis, such that the distribution linkage 20 can also be pivoted in the horizontal direction. The horizontal beam is at the same time part of a parallelogram suspension by means of which the central portion of the distribution linkage is held on the pivot frame.

The pivot frame can be pivoted about the axis D by means of the actuating device 38. A pivoting movement of the pivot frame results in a pivoting movement of the entire distribution linkage 20 about the axis D. The actuating device 38 comprises two hydraulically operating actuating elements (actuating cylinders). For the purpose of coupling the pivot frame with the actuating cylinders 38, the pivot frame also has a downwardly projecting V-shaped holder (concealed in FIG. 8B). The actuating cylinders 38 are arranged symmetrically on opposite sides - as viewed in the direction of travel V - of the holder and the pivot axis D, and are each fastened, at an end portion, to the downwardly projecting holder. For support, the actuating cylinders 38 are fastened via their other end portion to the support structure 33. Extending of one of the actuating cylinders 38 and simultaneously retracting of the other actuating cylinder 38 results in a pivoting movement of the pivot frame, relative to the carrier vehicle, about the pivot axis D extending in the direction of travel F. This results in a corresponding pivoting movement of the entire distribution linkage 20 in a plane perpendicular to the direction of travel.

For example, for a process of applying material, the control device 20 is configured to constantly controll a distance between an upper edge of the crop and the applicationelements device to a defined distance, by controlling, by closed-loop control, the pivot position of the distribution linkage 20 about the pivot axis D, and for this purpose accordingly generate control signals 31 for driving, or controlling by closed-loop control, the actuating cylinders 38. By means of the sensor device 10, which is configured to sense in anticipation changing vertical distances h between the distribution linkage 2 and the target area Z, actuating signals 31 for controlling the pivot position about the pivot axis D can advantageously be generated at an early stage by the control device 20.

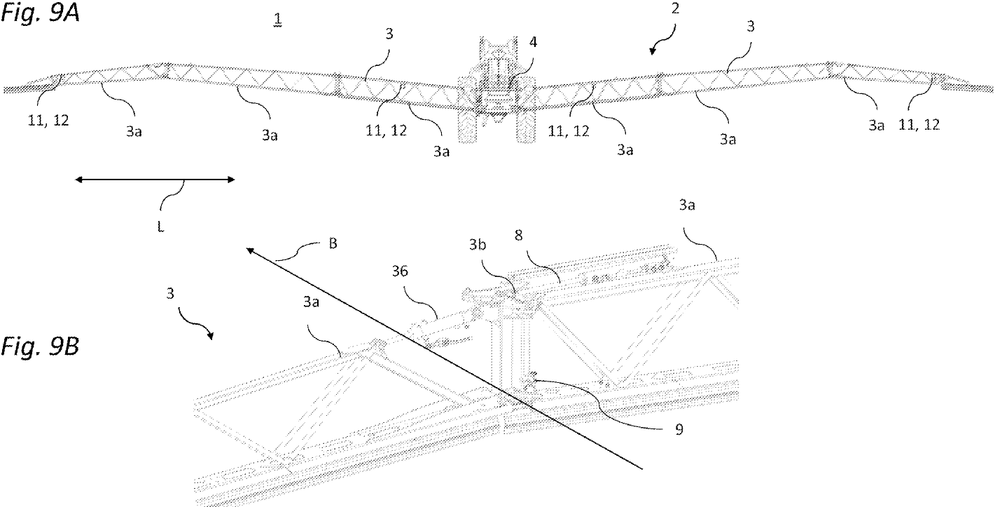

It has already been mentioned above that, in order to control the position of the distribution linkage 2, the distribution linkage 2, the booms 3 and optionally also individual segments 3a of the booms 3 can be pivoted about horizontal axes (boom axes A, segment axes B) extending in the direction of travel V, which is known per se from the prior art and will be explained in more detail below in connection with FIGS. 9A to 9B.

FIG. 9A shows a distribution linkage 2, comprising two lateral booms 3 and a central part 4, the lateral booms 3 each being mounted on the central part 4 of the distribution linkage 2 so as to be pivotable about an axis A extending in the direction of travel (cf. also FIG. 7A). The booms 3 may thus be angled relative to each other, as illustrated in FIG. 9A, which shows a slightly angled position. Both booms 3 are pivoted slightly upwards at the central part 4.

Furthermore, the booms 3 are each composed of three segments 3a, again arranged so as to be pivotable relative to each other about axes B extending in the direction of travel (cf. also FIG. 7A). Thus, adjacent segments 3a can also be angled relative to each other. This means that the booms, as viewed in the direction of longitudinal extent L of the booms, are each composed of a plurality of segments 3a connected by joints 3b.

This is shown in the detail view of FIG. 9B. Two adjacent segments (linkage portions) 3a connected by joints 3b comprise an inner and outer segment 3a (linkage section) in relation to the central part. According to this embodiment, the actuating device 30 additionally comprises actuating elements 36, by means of which the segments can be pivoted about the axes (segment axes) B running in the direction of travel. The actuating elements 36 are designed as hydraulic actuating cylinders. In other words, such an additional actuating element 36 which can be controlled by the control device 20 is assigned in each case to two adjacent segments 3a and/or to the joint 3b which forms the segment axis B. Accordingly, adjacent segments 3a may be angled relative to each other in order to set a separate vertical position for the individual segments 3a.

This is particularly advantageous for the individual adaptation of a vertical distance of each boom 3 and/or of individual segments 3a to an - as viewed in the direction of longitudinal extent L of the distribution linkage - uneven target area.

The present technology for anticipatory sensing of changing vertical distances of the distribution linkage may thus furthermore also be used advantageously for such a position control of the booms 3 and/or of the segments 3a, i.e. a position control, in particular a height control, that comprises an angling of the booms relative to each other and/or the angling of adjacent segments relative to each other based upon the changing vertical distances sensed in anticipation.

The sensor device 10, which configured to sense in anticipation changing vertical distances h between the distribution linkage 2 and the target area Z, can be used, advantageously, to generate actuating signals 31 at an early stage to control the pivot position about the pivot axis A.

For this purpose, the sensor device 10 comprises, per boom 3 or on at least two segments 3a per boom 3, respectively at least one close-range sensor 11, which is arranged on the respective boom or segment and is configured to sense actual relating to the vertical distance between the distribution linkage and the target area, and/or to scan an upcoming contour of the target area, and furthermore at least one far-range sensor 12 arranged on the respective boom or segment, which sensor is configured to sense upcoming relating to the vertical distance, and/or to scan an upcoming contour of the target area. In the example of FIG. 9A, both a close-range sensor 11 and a far-range sensor 12 are arranged, respectively, on the outermost segment 3a and the innermost segment 3a of each boom 3.

This offers the advantage that both an actual vertical distance (by means of the close-range sensor) and an upcoming change in height may be sensed in anticipation in a boom-specific manner or also for individual segments 3a of each boom. Accordingly, rapid but also precise position control with regard to vertical distances is made possible. System-related response times may be advantageously compensated, at least in part. According to these embodiments, there are thus a plurality of pairs of respectively one close-range sensor 11 and one far-range sensor 12, which are arranged at a distance from each other as viewed in the direction of longitudinal extent of the distribution linkage. The far-range sensors 12 and close-range sensors 11 may be realized as already described above. In this respect, reference is made to the explanations given above.

The invention is not limited to the preferred exemplary embodiments described above. Rather, a multiplicity of variants and modifications that also make use of the inventive concept, and therefore fall within the scope of protection, are possible. In particular, the invention also claims protection for the subject-matter and the features of the dependent claims, independently of the claims referred to.

List of references
1 agricultural distribution machine
2 distribution linkage
3 boom
3a boom segment
3b joint
4 central part
5 carrier vehicle
6 speed sensor, e.g. for travel speed, linkage speed
7 travel speed
8 folding cylinder
9 angular position transducer
10 sensor device
11 close-range sensor
12 far-range sensor
13 measurement data relating to the actual vertical distance, from close-range sensor, first measurement location)
14 measurement data relating to the upcoming vertical distance (from far-range sensor, second measurement location)
15 direction of view
16 pivotable sensor
17 direction of view
18 radar sensor
20 control device
21 vertical-position closed-loop control module
22 vertical-position pre-control module
22a module for determining change in contour
22b module for determining change in setpoint vertical position
22c time control module
23 calibration module
24 offset
25 setpoint vertical position
26 first operating mode
27 second operating mode
28 elapsed response times
30 actuating device
31 actuating signal
32 actuating device of height adjustment of central part
33 lifting frame
34 parallelogram linkage
35 actuating cylinder
36 actuating element, actuating cylinder
37 ball joint mount
38 actuating element, actuating cylinder
h vertical position, vertical distance
h1 actual vertical distance
h2, h3, h4, h5 upcoming vertical distance
A boom axis
B segment axis
D pivot axis, central part
P crop
Z target area
K contour of the target area
L direction of longitudinal extent of the distribution linkage
V direction of travel
Z vertical
M1, M2, M3, M4, M5 measurement location
S linkage oscillation
α1 angle of inclination of the direction of view to the vertical
α2 angle of inclination of the direction of view to the vertical

What is claimed and desired to be secured by letters patent is:

1. A mobile agricultural distribution machine having a first direction of travel and a travel speed, the machine comprising:
a) a distribution linkage for applying agricultural material, the distribution linkage comprising two lateral booms, each having a plurality of application elements for applying the material;
b) a controllable actuating device for altering a position of the distribution linkage relative to a target agricultural area to be worked;
c) a sensor device configured to sense in anticipation a change in vertical distance between the distribution linkage and the target area and/or upcoming changes in contour of the target area; and
d) a control device for the purpose of controlling the position of the distribution linkage, the control device being configured to generate actuating signals for the actuating device based upon at least one of the change in vertical distance sensed in anticipation and/or the changes in contour, in order to at least partially reduce a response time in the position control device.

2. The agricultural distribution machine according to claim 1, the sensor device being further configured to sense the vertical distance between the distribution linkage and the target area at a plurality of measurement locations that are spaced apart from each other in the direction of travel.

3. The agricultural distribution machine according to claim 1, wherein the sensor device is further configured to:
a) sense the vertical distance between the distribution linkage and the target area at a first measurement location and at a second measurement location; and/or
b) scan a contour of the target area at a first measurement location and at a second measurement location, the second measurement location being located at least partially ahead of the first measurement location when viewed in the direction of travel.

4. The agricultural distribution machine according to claim 3, the control device being further configured to determine a time point for the generation of an actuating signal in the position control based upon the travel speed and/or a variable derived therefrom, such that a travel time between the first measurement location and the second measurement location substantially corresponds to the response time of the actuating device in the position control.

5. The agricultural distribution machine according to claim 3, wherein:
a) the first measurement location corresponds to an area beneath or diagonally down ahead of the distribution linkage, and is between zero metres and one metre from the distribution linkage; and
b) the second measurement location is equidistant or further from the distribution linkage compared to the first measurement location, the second measurement location being between one metre and 50 metres from the distribution linkage.

6. The agricultural distribution machine according to claim 3, the control device being further configured to:
a) determine, based upon the measurement values sensed at the second measurement location, a change in vertical distance or a variable derived therefrom that indicates whether the vertical distance between the distribution linkage and the target area remains the same, decreases or increases in comparison with the current vertical distance; and
b) generate an actuating signal for the actuating device for the purpose of adapting the position of the distribution linkage to the change in vertical distance, before the distribution linkage reaches the second measurement location, based upon the determined change in vertical distance or the variable derived therefrom.

7. The agricultural distribution machine according to claim 1, the control device being further configured to determine a direction of a gradient of the vertical distance between the distribution linkage and the target area based upon the changing vertical distances sensed in anticipation and/or changes in contour.

8. The agricultural distribution machine according to claim 1, the control device being further configured to:
a) to determine a value for the actuating signal in proportion to a value of the changing vertical distance sensed in anticipation and/or of the change in contour; or
b) to generate, based upon the changing vertical distance sensed in anticipation and/or on the change in contour, an actuating signal that causes the position of the distribution linkage to be altered by an offset value relative to the agricultural target area to be worked.

9. The agricultural distribution machine according to claim 3, the control device being further configured to determine a vertical distance between the distribution linkage and the target area based upon the measurement values sensed at the first measurement location, and to use this determined distance to adjust the vertical distance between the distribution linkage and the target area to a predetermined setpoint vertical distance.

10. The agricultural distribution machine according to claim 3, the control device being further configured to:
a) determine, based upon the measurement values sensed by the sensor device, whether a switchover condition is fulfilled; and
b) if the switchover condition is fulfilled, to change from a first operating mode, in which the vertical distance of the distribution linkage is adjusted to a setpoint vertical distance based upon the measurement values sensed at the first measurement location, to a second operating mode, and in the second operating mode to generate, based upon the changing vertical distances sensed at the second measurement location, actuating signals for alteration of the position of the distribution linkage, which cause a current position of the distribution linkage to be altered in response to a change in vertical distance before the second measurement location is reached.

11. The agricultural distribution machine according to claim 10, wherein the switchover condition is fulfilled if a change in vertical distance between the distribution linkage and the target area, or a variable derived therefrom, based upon the measurement values sensed at the second measurement location, exceeds a predetermined threshold value.

12. The agricultural distribution machine according to claim 1, the control device being further configured to identify and filter out oscillations of the distribution linkage such that vertical oscillations and/or horizontal oscillations of the distribution linkage do not affect the determination of a vertical distance of the distribution linkage.

13. The agricultural distribution machine according to claim 1, the control device being further configured to form an average value based upon vertical distances determined at the first and second measurement locations, which is used to generate the actuating signals and/or to control the position of the distribution linkage.

14. The agricultural distribution machine according to claim 1, wherein the response time and/or a system speed in the controlling of the position of the distribution linkage is stored in the control device, and/or the control device being configured to determine the response time and/or the system speed on the basis of a time measurement.

15. A method for controlling the position of a distribution linkage of a mobile agricultural distribution machine having a distribution linkage for applying agricultural material, the distribution linkage having two lateral booms, each having a plurality of application elements for applying the material, the method comprising the steps of:
a) anticipatory sensing, by a sensor device, of a change in the vertical distance from the distribution linkage to a target area to be worked between a first measurement location and a second measurement location; and
b) based upon the change in vertical distances sensed in anticipation, generating actuating signals for an actuating device for the purpose altering a position of the distribution linkage relative to the target area;
wherein a response time in the position control of the distribution linkage is least partially reduced such that the actuating signals are generated before the distribution linkage reaches the second measurement location.

16. The agricultural distribution machine according to claim 5, wherein the second measurement location is between one metre and six metres from the distribution linkage.

17. The agricultural distribution machine according to claim 5, wherein the second measurement location is between six metres and 20 metres from the distribution linkage.

18. The agricultural distribution machine according to claim 5, wherein the second measurement location is between 20 metres and 50 metres from the distribution linkage.
